(19) United States
(12) Patent Application Publication
(10) Pub. No.: US 2024/0309947 A1
(43) Pub. Date: Sep. 19, 2024

(54) ELECTRIC VEHICLE

(71) Applicant: TOYOTA JIDOSHA KABUSHIKI KAISHA, Toyota-shi (JP)

(72) Inventors: Takeshi KUWAHARA, Toyota-shi (JP); Shinichiro SUENAGA, Nagoya-shi (JP); Ryo KAWAMOTO, Okazaki-shi (JP)

(73) Assignee: TOYOTA JIDOSHA KABUSHIKI KAISHA, Toyota-shi (JP)

(21) Appl. No.: 18/595,536

(22) Filed: Mar. 5, 2024

(30) Foreign Application Priority Data
Mar. 15, 2023 (JP) 2023-041406

(51) Int. Cl. F16H 57/04

(52) U.S. Cl. CPC F16H 57/0476; F16H 57/0413; F16H 57/043

(57) ABSTRACT

An electric vehicle includes: (a) an electric motor; (b) a power transmission device to which the electric motor is connected; (c) an electric oil pump configured to discharge an oil; (d) a cooling oil passage configured to supply the oil to the electric motor for cooling the electric motor; (e) a lubricating oil passage configured to supply the oil to the power transmission device for lubricating the power transmission device; (f) a branch portion configured to distribute the oil between the cooling oil passage and the lubricating oil passage; (g) an oil cooler provided in the cooling oil passage; and (h) a control valve which is provide in the branch portion and which is configured to make a ratio of a flow rate of the oil distributed to the lubricating oil passage higher when a temperature of the oil is low than when the temperature of the oil is high.

This application claims priority from Japanese Patent Application No. 2023-041406 filed on Mar. 15, 2023, the disclosure of which is herein incorporated by reference in its entirety.

### FIELD OF THE INVENTION

The present invention relates to an electric vehicle including an electric oil pump that discharges an oil used for cooling an electric motor and lubricating a power transmission device.

### BACKGROUND OF THE INVENTION

There is well-known an electric vehicle that includes: an electric motor; a power transmission device to which the electric motor is connected in a power transmittable manner; an electric oil pump configured to discharge an oil; a cooling oil passage configured to supply the oil to the electric motor for cooling the electric motor; a lubricating oil passage configured to supply the oil to the power transmission device for lubricating the power transmission device; and a branch portion configured to distribute the oil between the cooling oil passage and the lubricating oil passage. For example, a hybrid electric vehicle described in Patent Document 1 is such an electric vehicle. This patent document 1 discloses that a common oil passage connected to a discharge port of an electric oil pump is branched into a cooling oil passage and a lubricating oil passage in a branch portion that is located in a downstream-side end portion of the common oil passage.

### PRIOR ART DOCUMENT

### Patent Document

### Patent Document 1

Japanese Patent Application Laid-Open No. 2020-82963

### SUMMARY OF THE INVENTION

Here, it is conceivable to provide an oil cooler in the common oil passage connected to the electric oil pump, and to cool the oil on an upstream side of the branch portion. A viscosity of the oil is higher when a temperature of the oil is low than when the temperature of the oil is high. With increase of the viscosity of the oil, a pressure loss of the oil passing through the oil cooler is increased, and a flow rate of the oil required for lubricating the power transmission device may not be obtained. If the electric oil pump is increased in output to ensure the flow rate of the oil required for lubricating the power transmission device, the electric oil pump may be increased in size, or the flow rate may be excessive with respect to the flow rate required for cooling the electric motor, which may increase a stirring loss and deteriorate an energy efficiency.

The present invention has been made in view of the above circumstances, and an object of the present invention is to provide an electric vehicle in which, even when a temperature of an oil is low, it is possible to obtain a flow rate of the oil required for lubrication of a power transmission device while suppressing an increase of an output of an electric oil pump.

According to a first aspect of the invention, there is provided an electric vehicle including: (a) an electric motor; (b) a power transmission device to which the electric motor is connected in a power transmittable manner; (c) an electric oil pump configured to discharge an oil; (d) a cooling oil passage configured to supply the oil to the electric motor for cooling the electric motor; (c) a lubricating oil passage configured to supply the oil to the power transmission device for lubricating the power transmission device; (f) a branch portion configured to distribute the oil between the cooling oil passage and the lubricating oil passage; (g) an oil cooler provided in the cooling oil passage; and (h) a control valve which is provide in the branch portion and which is configured to make a ratio of a flow rate of the oil distributed to the lubricating oil passage higher when a temperature of the oil is low than when the temperature of the oil is high.

According to the first aspect of the invention, the electric vehicle includes: the cooling oil passage for supplying the oil for cooling the electric motor; the lubricating oil passage for supplying the oil for lubricating the power transmission device; and the oil cooler provided in the cooling oil passage. The branch portion for distributing the oil between the cooling oil passage and the lubricating oil passage is provided with the control valve for increasing the ratio of the flow rate of the oil distributed to the lubricating oil passage when the temperature of the oil is low as compared with when the temperature of the oil is high. Thus, at a relatively low temperature when the necessity of cooling the electric motor is low, the oil is distributed preferentially to the lubricating oil passage, and the oil is supplied to the lubricating oil passage without passing through the oil cooler, so that a lubricating performance for the power transmission device is secured. Therefore, it is possible to obtain the flow rate of the oil required for lubricating the power transmission device even when the temperature of the oil is low while suppressing an increase of an output of the electric oil pump.

### BRIEF DESCRIPTION OF THE DRAWINGS

FIG. 1 is a view schematically showing, by way of example, a construction of an electric vehicle to which the present invention is applied.

FIG. 2 is a view showing, by way of example, an electrical configuration related to control of an electric motor and the like.

FIG. 3 is a view schematically showing, by way of example, a construction of an mechanical-electrical integrated unit.

FIG. 4 is a view schematically showing, by way of example, a system for circulating an oil.

FIG. 5 is a view showing, by way of example, a structure of a cover of a casing, for circulating the oil.

### DETAILED DESCRIPTION OF PREFERRED EMBODIMENT

Hereinafter, an embodiment of the present invention will be described in detail with reference to the drawings.

### Embodiment

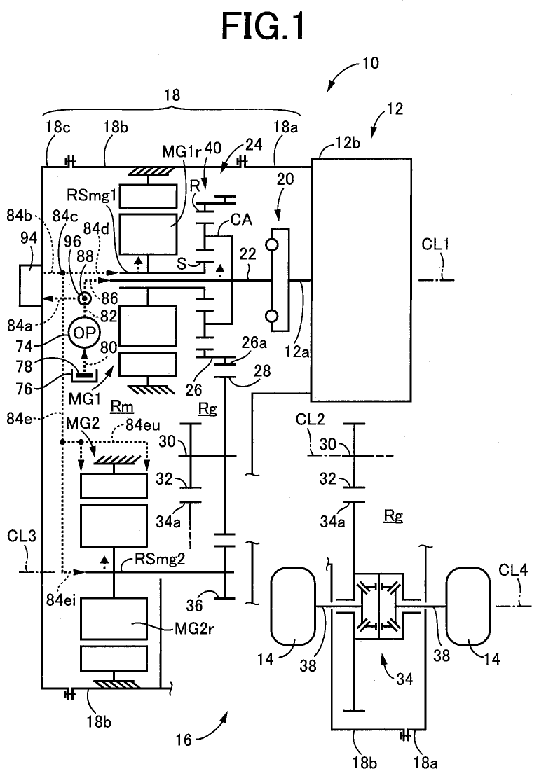

FIG. 1 is a view schematically showing a construction of an electric vehicle 10 to which the present invention is applied. In FIG. 1, the electric vehicle 10 is a hybrid electric vehicle including an engine 12 functioning as a power source and a second electric motor MG2 that is an electric motor functioning as a power source. The electric vehicle 10 (hereinafter simply referred to as “vehicle 10”) includes drive wheels 14, a power transmission device 16 and a first electric motor MG1.

The engine 12 is a known internal combustion engine. The drive wheels 14 are left and right wheels with respect to forward and backward directions of the vehicle 10. The power transmission device 16 is provided in a power transmission path between the engine 12 and the drive wheels 14 and a power transmission path between the second electric motor MG2 and the drive wheels 14.

The first electric motor MG1 and the second electric motor MG2 are known rotary electric machines, so-called motor generators, each having a function as a motor that generates a mechanical power from an electric power and a function as a power generator that generates an electric power from a mechanical power. The first electric motor MG1 and the second electric motor MG2 are provided in a non-rotatable casing 18 which is a non-rotatable member attached to a body of the vehicle 10.

The power transmission device 16 includes a damper 20, an input shaft 22, a transmission portion 24, a composite gear 26, a driven gear 28, a driven shaft 30, a final gear 32, a differential gear device 34 and a reduction gear 36 that are housed in the casing 18. The power transmission device 16 includes an MG1 rotor shaft RSmg1 and an MG2 rotor shaft RSmg2 that are housed in the casing 18. The power transmission device 16 includes a pair of drive shafts 38 connected to the differential gear device 34.

The damper 20 is connected to a crankshaft 12a of the engine 12. The input shaft 22 functions as an input rotary member of the transmission portion 24. The input shaft 22 is connected to the damper 20, and is connected to the crankshaft 12a via the damper 20 and the like. The transmission portion 24 is connected to the input shaft 22. The composite gear 26 is a rotary body on an output side of the transmission portion 24. The composite gear 26 has a drive gear 26a formed on a part of an outer peripheral surface thereof. The drive gear 26a is an output-side rotary member of the transmission portion 24. The driven gear 28 meshes with the drive gear 26a. The driven gear 28 and the final gear 32 are fixed onto the driven shaft 30 so as not to be relatively rotatable. The final gear 32 has a smaller diameter than the driven gear 28 and meshes with the differential ring gear 34a. The reduction gear 36 has a smaller diameter than the driven gear 28 and meshes with the driven gear 28. The MG1 rotor shaft RSmg1 is a rotor shaft of the first electric motor MG1 and is integrally connected to the rotor MG1r of the first electric motor MG1. The MG2 rotor shaft RSmg2 is a rotor shaft of the second electric motor MG2 and is integrally connected to a rotor MG2r of the second electric motor MG2. The MG2 rotor shaft RSmg2 is connected to the reduction gear 36, so that the second electric motor MG2 is connected to the reduction gear 36 in a power transmittable manner.

The power transmission device 16 constructed as described above is suitably used for a vehicle of a front engine front drive (FF) type or a rear engine rear drive (RR) type. The power transmission device 16 transmits a power outputted from the engine 12 to the driven gear 28 via the transmission portion 24. The power transmission device 16 transmits a power outputted from the second electric motor MG2 to the driven gear 28 via the reduction gear 36. The power transmission device 16 transmits the power transmitted to the driven gear 28 to the drive wheels 14 sequentially via the driven shaft 30, the final gear 32, the differential gear device 34, the drive shafts 38 and the like. The driven gear 28, the driven shaft 30, and the final gear 32 constitute a transmission mechanism that transmits the power from the second electric motor MG2 to the drive gear 26a. The differential gear device 34 distributes the power from the engine 12 and the second electric motor MG2 to the drive wheels 14. The drive shafts 38 transmits the power from the differential gear device 34 to the drive wheels 14. The second electric motor MG2 is connected to the drive wheels 14 in a power transmittable manner.

The transmission portion 24 includes the first electric motor MG1, the MG1 rotor shaft RSmg1 and a differential mechanism 40. The differential mechanism 40 is a known single-pinion planetary gear device including a sun gear S, a carrier CA and a ring gear R. The sun gear S is connected to the MG1 rotor shaft RSmg1. That is, the first electric motor MG1 as an electric motor is connected to the differential mechanism 40 as a part of the power transmission device 16 in a power transmittable manner. The carrier CA is connected to the input shaft 22. That is, the differential mechanism 40 is connected to the engine 12 via the input shaft 22 and the like in a power transmittable manner. The ring gear R is formed on a part of an inner peripheral surface of the composite gear 26, and is integrally connected to the drive gear 26a. That is, the differential mechanism 40 is connected to the drive wheels 14 in a power transmittable manner.

The differential mechanism 40 functions as a differential mechanism which is connected to the engine 12 in a power transmittable manner and which generates a differential action. The first electric motor MG1 is a differential-purpose electric motor that is connected to the differential mechanism 40 in a power transmittable manner. The differential mechanism 40 is a power split mechanism that mechanically splits the power of the engine 12 to the first electric motor MG1 and the drive gear 26a. The transmission portion 24 is a known electric transmission mechanism in which a differential state of the differential mechanism 40 is controlled with an operation state of the first electric motor MG1 being controlled.

The power transmission device 16 has a first axis CL1, a second axis CL2, a third axis CL3 and a fourth axis CL4. These four axes CL1, CL2, CL3, CL4 are parallel to one another. The first axis CL1 is an axis of each of the input shaft 22 and the MG1 rotor shaft RSmg1. That is, the first axis CL1 is a rotation axis of the first electric motor MG1. The transmission portion 24 and the first electric motor MG1 are disposed around the first axis CL1. The second axis CL2 is an axis of the driven shaft 30. The driven gear 28 and the final gear 32 are disposed around the second axis CL2. That is, the second axis CL2 is a rotation axis of each of the driven gear 28, the driven shaft 30 and the final gear 32. The third axis CL3 is an axis of the MG2 rotor shaft RSmg2. That is, the third axis CL3 is a rotation axis of the second electric motor MG2. The second electric motor MG2 and the reduction gear 36 are disposed around the third axis CL3. The fourth axis CL4 is an axis of each of the drive shafts 38. That is, the fourth axis CL4 is a rotation axis of each of the drive shafts 38 and the differential gear device 34. The differential gear device 34 is disposed around the fourth axis CL4. The second axis CL2 and the fourth axis CL4 are rotation axes of the power transmission device 16.

The casing 18 includes a housing 18a, a main body 18b and a cover 18c. The housing 18a includes an opening portion on a side of the engine 12. The engine 12 includes an engine block 12b that is connected to the opening portion of the housing 18a. The housing 18a includes another opening portion that is remote from the engine 12. The housing 18a and the main body 18b are integrally connected by fasteners such as bolts such that the another opening portion of the housing 18a and an opening portion of the main body 18b, which are opposed to each other, are aligned with each other. The main body 18b and the cover 18c are integrally connected by fasteners such as bolts such that the cover 18c closes another opening portion of the main body 18b that is remote from the engine 12. The main body 18b is a casing including a partition wall (not shown) that separates a gear room Rg and a motor room Rm from each other, wherein the gear room Rg houses the transmission portion 24, the driven gear 28, the deferential gear device 34 and the like, while the motor room Rm houses the first electric motor MG1 and the second electric motor MG2. The main body 18b cooperates with the housing 18a to form the gear room Rg. The main body 18b forms a motor room Rm together with the cover 18c. The main body 18b houses the differential gear device 34 and the like. The cover 18c is a casing cover connected to the main body 18b so as to cover the above-described another opening portion of the main body 18c that is remote from the engine 12. Thus, the casing 18 houses the first electric motor MG1, the second electric motor MG2 and the power transmission device 16 except the drive shafts 38 and the like.

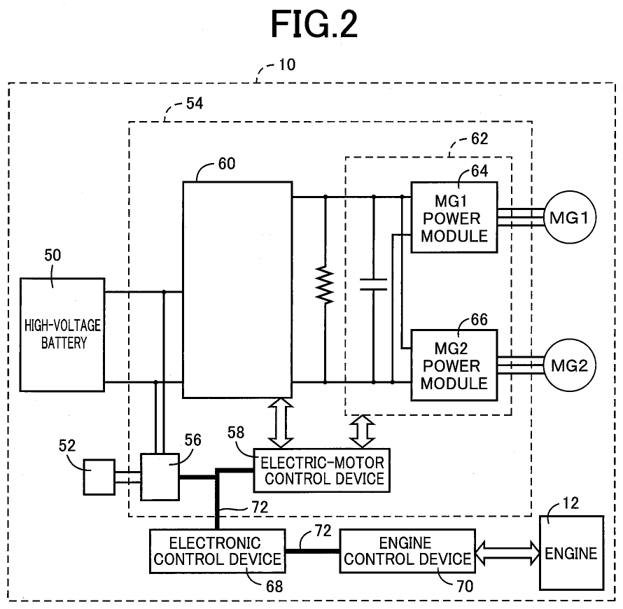

FIG. 2 is a view showing, by way of example, an electrical configuration related to control of the first and second electric motors MG1, MG2, for example. In FIG. 2, the vehicle 10 further includes a high-voltage battery 50, an auxiliary battery 52 and an electric-power control unit 54.

The high-voltage battery 50 is a chargeable and dischargeable DC power supply, and is a secondary battery such as a nickel-hydrogen secondary battery or a lithium ion battery. The high-voltage battery 50 is connected to the electric-power control unit 54. The stored electric power is supplied from the high-voltage battery 50 to, for example, the second electric motor MG2 via the electric-power control unit 54. The high-voltage battery 50 is supplied with the electric power generated by the first electric motor MG1 and the electric power regenerated by the second electric motor MG2 via the electric-power control unit 54. The high-voltage battery 50 is a driving battery.

The electric-power control unit 54 includes a DC-DC converter 56, an electric-motor control device 58, a boost converter 60 and an inverter 62. The electric-power control unit 54 is an electric-power control apparatus that controls the electric power transmitted and received between the high-voltage battery 50 and each of the first electric motor MG1 and the second electric motor MG2.

The DC-DC converter 56 is connected to the high-voltage battery 50. The DC-DC converter 56 functions as a charging device that reduces a voltage of the high-voltage battery 50 to a voltage equivalent to a voltage of the auxiliary battery 52, and charges the auxiliary battery 52. The auxiliary battery 52 supplies the electric power for operating auxiliary devices, the electric-motor control device 58, an electronic control device 68, an engine control device 70 and the like, which are provided in the vehicle 10.

The boost converter 60 includes a reactor and a switching element (not shown). The boost converter 60 is a step-up/down circuit having a function of boosting the voltage of the high-voltage battery 50 and supplying the boosted voltage to the inverter 62, and a function of reducing the voltage converted into a direct current by the inverter 62 and supplying the reduced voltage to the high-voltage battery 50.

The inverter 62 includes an MG1 power module 64 and an MG2 power module 66. Each of the MG1 power module 64 and the MG2 power module 66 includes switching elements (not shown). The inverter 62 converts the direct current from the boost converter 60 into an alternating current for driving the first electric motor MG1 and the second electric motor MG2. The inverter 62 converts the alternating current generated by the first electric motor MG1 using the power of the engine 12 and the alternating current generated by the second electric motor MG2 using the regenerative braking, into the direct current. The inverter 62 supplies the alternating current generated by the first electric motor MG1, as the driving power of the second electric motor MG2, in accordance with a running state of the vehicle 10.

The vehicle 10 further includes the electronic control device 68, the engine control device 70 and communication lines 72.

The electronic control device 68 transmits and receives signals to and from the DC-DC converter 56, the electric-motor control device 58, the engine control device 70 and the like via the communication lines 72. The electronic control device 68 performs various controls for the vehicle 10 based on signals supplied from sensors (not shown), for example. The communication lines 72 are, for example, known controller area network (CAN) communication lines.

The electric-motor control device 58 controls the boost converter 60 and the inverter 62 based on commands from the electronic control device 68, so as to control the first electric motor MG1 and the second electric motor MG2. For example, the electric-motor control device 58 converts the direct current supplied from the high-voltage battery 50, into the alternating current used for each of the first electric motor MG1 and the second electric motor MG2. The electric-motor control device 58 drives the first electric motor MG1 to secure the amount of power generation required for supplying the power to the second electric motor MG2 and charging the high-voltage battery 50. The electric-motor control device 58 drives the second electric motor MG2 based on a power demand value corresponding to the torque demanded by a driver of the vehicle 10. The electric-motor control device 58 causes the second electric motor MG2 to function as the power generator in accordance with the required amount of regenerative braking.

The engine control device 70 controls the engine 12 based on a command from the electronic control device 68. For example, the engine control device 70 drives an electronic throttle valve, an ignition device, a fuel injection device and the like, and controls the output of the engine 12.

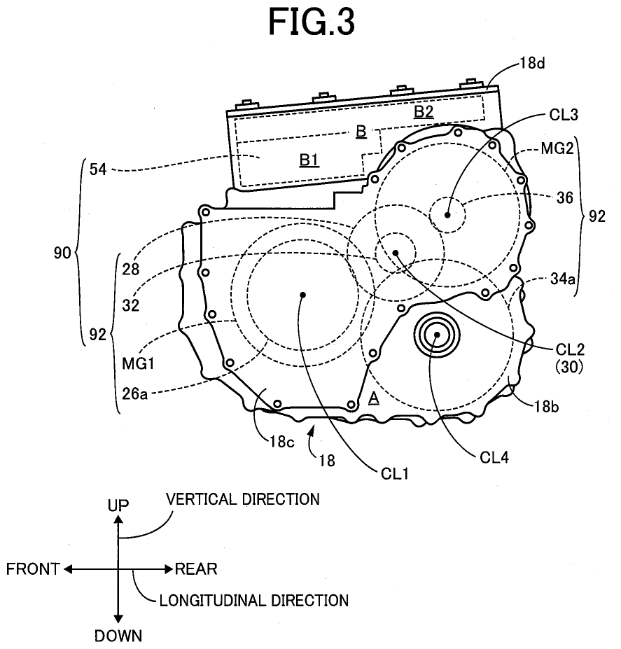

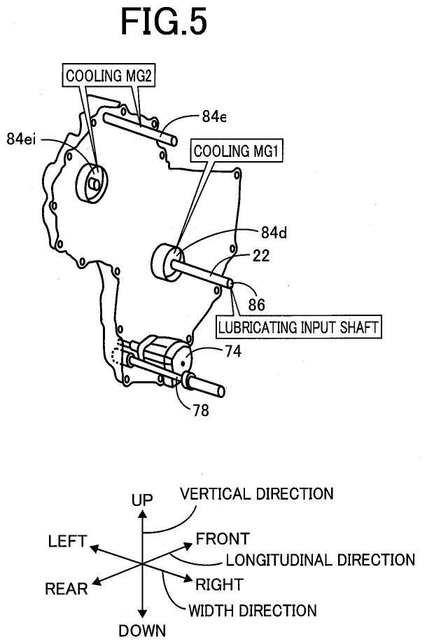

FIG. 3 view schematically showing, by way of example, a construction of a hybrid drive unit 90. FIG. 3 is a side view of the vehicle 10 as viewed from a left side of the vehicle 10. As shown in FIG. 3, a transaxle 92 and the electric-power control unit 54 constitute the hybrid drive unit 90, and are housed in the same casing 18. The hybrid drive unit 90 is a mechanical-electrical integrated unit, i.e., a unit in which the transaxle 92 and the electric-power control unit 54 are integrated. The transaxle 92 is a drive apparatus including the power transmission device 16 (26a, 28, 32, 34a, 36, etc.), the first electric motor MG1 and the second electric motor MG2. It is noted that “VERTICAL DIRECTION”, “LONGITUDINAL DIRECTION” and “WIDTH DIRECTION” (see FIG. 5) in the drawings indicate directions in the vehicle 10. The “WIDTH DIRECTION” is parallel to an axial direction corresponding to each of the first axis CL1, the second axis CL2, the third axis CL3 and the fourth axis CL4.

The casing 18 further includes a protection plate 18d in addition to the above-described housing 18a, main body 18b and cover 18c. The main body 18b includes a bottom wall and side walls that extend upward in the vertical direction from an outer peripheral edge of the bottom wall on front and rear sides in the longitudinal direction of the vehicle 10, and opens in its upper portion in the vertical direction of the vehicle 10. The protection plate 18d is a plate-shaped member that closes an opening in the upper portion of the main body 18b. The main body 18b has a partition wall (not shown) inside, such that an inner space of the main body 18b is divided into two spaces by the partition wall, wherein the two spaces are a space A as a lower portion of the inner space of the main body 18b in the vertical direction and a space B as an upper portion of the inner space of the main body 18b in the vertical direction.

When being installed in the vehicle 10, the transaxle 92 is housed in the housing 18a and the space A as the lower portion of the inner space of the main body 18b.

When being installed in the vehicle 10, the electric-power control unit 54 is housed in the space B as the upper portion of the inner space of the main body 18b. The space B includes a surplus space B1 and a space B2. The surplus space B1 is formed by arrangement of the first electric motor MG2 and the second electric motor B1. The space B2 is located on an upper side of the second electric motor MG2 in the vertical direction. The surplus space B1 is shorter than the space B2 in the longitudinal direction of the vehicle 10. That is, the electric-power control unit 54 is disposed adjacent to and above the first electric motor MG1 in the vertical direction of the vehicle 10.

For example, components having a relatively short length in the electric-power control unit 54 are housed in a lower portion of the surplus space B1 in the vertical direction. In addition, some components are housed in an upper portion of the surplus space B1 in the vertical direction, for example, in consideration of easiness of replacement.

Referring to FIG. 3, the transaxle 92 is disposed such that the first axis CL1, the second axis CL2, the third axis CL3 and the fourth axis CL4 are parallel to a horizontal direction perpendicular to the longitudinal direction of the vehicle 10. Further, the first axis CL1, the second axis CL2, the third axis CL3 and the fourth axis CL4 are located relative to one another, such that the second electric motor MG2, the driven shaft 30, the first electric motor MG1 and the differential gear device 34 are arranged in this order of description from above to below in the vertical direction, and such that the first electric motor MG1, the driven shaft 30, the differential gear device 34 and the second electric motor MG2 are arranged in this order of description from front to rear in the longitudinal direction. Focusing on the first electric motor MG1 and the second electric motor MG2, the transaxle 92 is disposed such that the third axis CL3 and the first axis CL1 are arranged in this order of description from above to below in the vertical direction. Thus, a vertical size of the transaxle 92 is reduced while distances among the first axis CL1, the second axis CL2, the third axis CL3 and the fourth axis CL4 are appropriately ensured. Therefore, the surplus space B1 is created by the arrangement of the first electric motor MG2 and the second electric motor B1, and the space MG2 is created above the second electric motor B2 in the vertical direction. The electric-power control unit 54 is disposed in the space B (B1+B2).

When being installed in the vehicle 10, the electric-power control unit 54 is disposed vertically above the transaxle 92. In addition, the electric-power control unit 54 is disposed in a position in which a lower-side portion of the electric-power control unit 54 overlaps with the transaxle 92, particularly, an upper-side portion of the second electric motor MG2, in the horizontal direction, particularly, in the longitudinal direction. In other words, when the electric-power control unit 54 is installed in the vehicle 10, the lower-side portion of the electric-power control unit 54 is disposed vertically above the first electric motor MG1.

The electric-power control unit 54 is disposed in a space created by reduction of the vertical size of the transaxle 92, and a space is created vertically above the hybrid drive unit 90.

In the vehicle 10, the first electric motor MG1 and the second electric motor MG2 are cooled by circulation of the oil FLD. The oil FLD is used also for lubrication of the power transmission device 16.

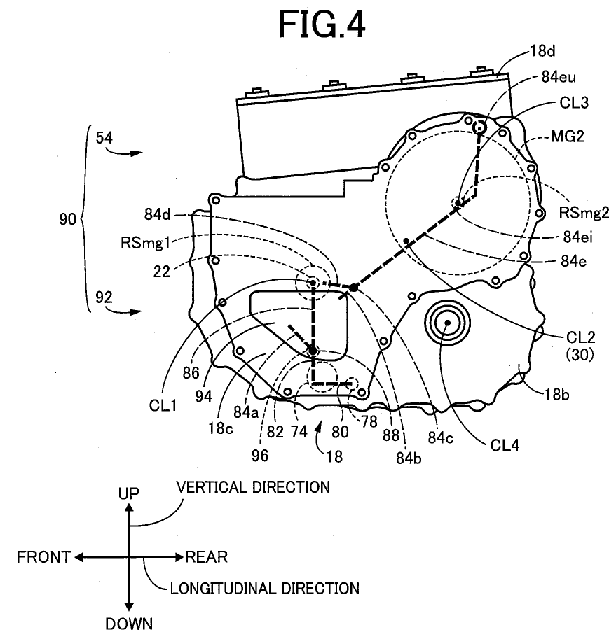

FIG. 4 is a view schematically showing, by way of example, a system for circulating the oil FLD. FIG. 5 is a view showing, by way of example, a structure of the cover 18c of the casing 18, for circulating the oil FLD. FIG. 4 is a side view as viewed from a left side of the vehicle 10. FIG. 5 is a perspective view as viewed from a right diagonal side of the vehicle 10.

As shown in FIGS. 1, 4 and 5, the vehicle 10 further includes an electric oil pump 74, an oil storage portion 76, a strainer 78, an intake oil passage 80, a discharge oil passage 82, a cooling oil passage 84, a lubricating oil passage 86 and a branch portion 88 that are disposed in the casing 18.

The oil storage portion 76 is an oil reservoir provided in a bottom portion of the gear room Rg and in which the oil FLD is stored. The electric oil pump 74 is driven based on a command supplied from the electronic control device 68, so as to receive the oil FLD supplied from the oil storage portion 76 via the strainer 78 and the intake oil passage 80, and discharge the oil FLD to the discharge oil passage 82. The cooling oil passage 84 is an oil passage configured to supply the oil FLD discharged from the electric oil pump 74, to the first electric motor MG1 and the second electric motor MG2 for cooling the first electric motor MG1 and the second electric motor MG2. The lubricating oil passage 86 is an oil passage configured to supply the oil FLD discharged from the electric oil pump 74, to the power transmission device 16 for lubrication of the power transmission device 16. The branch portion 88 is a branch point at which the oil FLD discharged from the electric oil pump 74 is distributed between the cooling oil passage 84 and the lubricating oil passage 86.

In order to cool the first electric motor MG1 and the second electric motor MG2, it is necessary to cool the oil FLD. The vehicle 10 further includes an oil cooler 94 attached to the casing 18, for example, to an outside of the cover 18c. The oil cooler 94 is a heat exchanger or the like that cools the oil FLD by heat exchange. In the oil cooler 94, the oil FLD is cooled by using, for example, an electric or mechanical cooling fan or the like, or the oil FLD is cooled by using a refrigerant such as a coolant.

By the way, when an oil temperature THfld is low, a viscosity of the oil FLD is higher than when the oil temperature THfld is high, so that a pressure loss of the oil FLD passing through the oil cooler 94 is increased. Therefore, if the oil FLD that has passed through the oil cooler 94 is used, a flow rate of the oil FLD required for lubricating the power transmission device 16 may not be obtained. It is desired to obtain the flow rate of the oil FLD required for the lubrication of the power transmission device 16 even when the oil temperature THfld is low without increasing an output of the electric oil pump 74. The oil temperature THfld, which is a temperature of the oil FLD, is detected by an oil temperature sensor (not shown), and a signal indicative of the detected oil temperature THfld is inputted to the electronic control device 68.

When the oil temperature THfld is low, the necessity of cooling the first electric motor MG1 and the second electric motor MG2 is reduced. Therefore, in the vehicle 10, the oil cooler 94 is provided in the cooling oil passage 84. In addition, the vehicle 10 further includes a control valve 96 that is provided in the branch portion 88, so as to increase a ratio of the flow rate of the oil FLD distributed to the lubricating oil passage 86 when the oil temperature THfld is low, as compared with when the oil temperature SL is high. For example, the control valve 96 is driven based on a command from the electronic control device 68, and is opened and closed so as to control the flow rate of the oil FLD distributed to a pre-cooler intermediate oil passage 84a that is an oil passage between the branch portion 88 and the oil cooler 94. The pre-cooler intermediate oil passage 84a constitutes a part of the cooling oil passage 84. The control valve 96 is fully closed when the oil temperature THfld is not higher than a predetermined oil temperature value THfldf. On the other hand, the control valve 96 is fully opened when the oil temperature THfld is higher than the predetermined oil temperature value THfldf. The predetermined oil temperature value THfldf is a predetermined value for determining that the oil temperature is so extremely low that the first electric motor MG1 and the second electric motor MG2 do not need to be cooled.

However, the control valve 96 is fully opened when an MG1 temperature THmg1 is higher than a predetermined motor temperature value THmg1f, regardless of the oil temperature THfld. The control valve 96 is fully opened when an MG2 temperature THmg2 is higher than a predetermined motor temperature value THmg2f, regardless of the oil temperature THfld. The MG1 temperature THmg1, which is a temperature of the first electric motor MG1, is detected by an MG1 temperature sensor (not shown), and a signal indicative of the detected MG1 temperature THmg1 is inputted to the electronic control device 68. The MG2 temperature THmg2, which is a temperature of the second electric motor MG2, is detected by an MG2 temperature sensor (not shown), and a signal indicative of the detected MG2 temperature THmg2 is inputted to the electronic control device 68. The predetermined motor temperature value THmg1f is a predetermined value for determining that the temperature is high enough to require cooling of the first electric motor MG1. The predetermined motor temperature value THmg2f is a predetermined value for determining that the temperature is high enough to require cooling of the second electric motor MG2.

The cooling oil passage 84 includes a post-cooler intermediate oil passage 84b, an MG1/2 branch portion 84c, an MG1 cooling oil passage 84d and an MG2 cooling oil passage 84e, in addition to the pre-cooler intermediate oil passage 84a. The post-cooler intermediate oil passage 84b is an oil passage which is located on a downstream side of the oil cooler 94 and between the oil cooler 94 and the MG1/2 branch portion 84c. The MG1/2 branch portion 84c is a branch point at which the oil FLD supplied to the post-cooler intermediate oil passage 84b through the oil cooler 94 is distributed between the MG1 cooling oil passage 84d and the MG2 cooling oil passage 84c. The MG1 cooling oil passage 84d is an oil passage through which the oil FLD is to be supplied to the first electric motor MG1 for cooling the first electric motor MG1. The MG2 cooling oil passage 84e is an oil passage through which the oil FLD is to be supplied to the second electric motor MG2 for cooling the second electric motor MG2.

The MG1 cooling oil passage 84d has a pipe located on the first axis CL1 so as to be provided in the MG1 rotor shaft RSmg1 having a hollow shape. The MG1 rotor shaft RSmg1 is provided with discharge holes each penetrating in a radial direction of the MG1 rotor shaft RSmg1, so that the oil FLD is made to flow out from the discharge holes to the outer peripheral side so as to be supplied to the first electric motor MG1. In this way, the cooling oil passage 84 is provided to supply the oil FLD to the first electric motor MG1 via the MG1 rotor shaft RSmg1. Since the electric-power control unit 54 is disposed adjacent to and above the first electric motor MG1 in the vertical direction, it is difficult to mount an overlay oil passage. Therefore, in the vehicle 10, the first electric motor MG1 is cooled by a so-called cooling from axial center, rather than a so-called cooling from above.

The MG2 cooling oil passage 84e includes an MG2 overlay oil passage 84cu that is an oil passage disposed adjacent to and above the second electric motor MG2 in the vertical direction. The MG2 overlay oil passage 84cu is provided to extend in the widthwise direction of the vehicle 10. The MG2 overlay oil passage 84cu is provided with a plurality of discharge holes that open downward in the vertical direction, and the oil FLD is caused to flow downward from the discharge holes so as to be supplied to the second electric motor MG2. In this way, the cooling oil passage 84 is provided to supply the oil FLD to the second electric motor MG2 via the MG2 overlay oil passage 84cu.

Further, in the second electric motor MG2, in addition to the cooling from above, the cooling from axial center may be provided. For example, the MG2 cooling oil passage 84e has an MG2 axial oil passage 84ci that is defined by a pipe located on the third axis CL3 so as to be provided in the hollow MG2 rotor shaft RSmg2 having a hollow shape. The hollow MG2 rotor shaft RSmg2 is provided with discharge holes each penetrating in a radial direction of the MG2 rotor shaft RSmg2, so that the oil FLD is made to flow out from the discharge holes to the outer peripheral side so as to be supplied to the second electric motor MG2.

The lubricating oil passage 86 has a pipe located on the first axis CL1 so as to be provided in the input shaft 22 having a hollow shape. The input shaft 22 extends through the hollow of the MG1 rotor shaft RSmg1, and is rotatable relative to the MG1 rotor shaft RSmg1. The input shaft 22 is provided with discharge holes each penetrating in a radial direction of the input shaft 22, so that the oil FLD is caused to flow out from the discharge holes to the outer peripheral side so as to be supplied to the differential mechanism 40 and the like.

As described above, according to the present embodiment, the vehicle 10 includes: the oil cooler 94 provided in the cooling oil passage 84; and the control valve 96 provided in the branch portion 88 and configured to increase the ratio of the flow rate of the oil FLD distributed to the lubricating oil passage 86 when the oil temperature THfld is low as compared to when the oil temperature SL is high. Thus, at a relatively low temperature at which the necessity of cooling the first electric motor MG1 and the second electric motor MG2 is low, the oil FLD is preferentially distributed to the lubricating oil passage 86, and the oil FLD is supplied to the lubricating oil passage 86 without passing through the oil cooler 94, so that a lubrication performance for the power transmission device 16 is secured. Therefore, the flow rate of the oil FLD required for lubricating the power transmission device 16 can be obtained even when the oil temperature THfld is low, while suppressing an increase of the output of the electric oil pump 74.

Further, according to the present embodiment, the control valve 96 is fully closed when the oil temperature THfld is not higher than the predetermined oil temperature value THfldf. Thus, since the oil FLD is avoided from being excessively supplied to the first electric motor MG1 and the second electric motor MG2, a stirring loss is reduced, and an energy efficiency can be improved. Therefore, the flow rate of the oil FLD required for lubrication and cooling can be reduced, and the size of the electric oil pump 74 can be reduced.

Further, according to the present embodiment, the control valve 96 is fully opened when the MG1 temperature THmg1 is higher than the predetermined motor temperature value THmg1f or when the MG2 temperature THmg2 is higher than the predetermined motor temperature value THmg2f. Thus, the oil FLD is appropriately supplied when the first electric motor MG1 or the second electric motor MG2 needs to be cooled, regardless of the oil temperature THfld.

According to the present embodiment, the cooling oil passage 84 is provided to supply the oil FLD to the first electric motor RSmg1 via the MG1 rotor shaft MG1. Thus, in the hybrid drive unit 90 in which the transaxle 92 and the electric-power control unit 54 are housed in the same casing 18, the oil FLD is appropriately supplied by the cooling from axial center in the first electric motor MG1 in which the cooling from above is difficult.

Further, according to the present embodiment, the cooling oil passage 84 is provided to supply the oil FLD to the second electric motor MG2 via the MG2 overlay oil passage 84eu. Thus, in the hybrid drive unit 90, the oil FLD is appropriately supplied to the second electric motor MG2 by the upper cooling.

Although the embodiment of the present invention have been described in detail with reference to the drawings, the present invention is also applicable to other forms.

For example, in the above-described embodiment, the control valve 96 may be closed to a degree smaller than the fully open state when the oil temperature THfld is not higher than the predetermined oil temperature value THfldf. Even in this case, the ratio of the flow rate of the oil FLD distributed to the lubricating oil passage 86 is increased when the oil temperature THfld is low, as compared to when the oil temperature THfld is high.

In the above-described embodiment, the transaxle 92 may be provided in the vehicle 10 with the first axis CL1, the second axis CL2, the third axis CL3 and the fourth axis CL4 being located relative to one another, such that the first electric motor CL1, the driven shaft 30, the differential gear device 34 and the second electric motor CL2 are arranged in this order of description from rear to front in the longitudinal direction. Further, the transaxle 92 and the electric-power control unit 54 may be housed in respective casings separated from each other. Further, the electric-power control unit 54 does not necessarily have to be located above the transaxle 92 in the vertical direction.

In the above-described embodiment, the electric vehicle may be an electric vehicle including a driving electric motor. In this case, for example, in arrangement positions of the respective components of the transaxle 92 shown in FIG. 3, the first electric motor MG1 is removed, and the second electric motor MG2 functions as an electric motor of the electric vehicle. Alternatively, the electric vehicle may be a series hybrid electric vehicle including an engine, a driving electric motor that functions as a power source and an electric motor which is connected to the engine in a power transmittable manner and which generates an electric power by the power of the engine. In such a series hybrid electric vehicle, a power transmission path between the engine and the drive wheels may be disconnected or connected by operation of a clutch. Alternatively, the electric vehicle may be a parallel hybrid electric vehicle including an engine, a power transmission device that transmits the power from the engine to the drive wheels and an electric motor that transmits the power to the drive wheels via the power transmission device.

In the above-described embodiment, the electric vehicle 10 may be a so-called plug-in hybrid electric vehicle in which the high-voltage battery 50 can be charged with the electric power from an external power supply. In the plug-in hybrid vehicle, a degree of freedom of arrangement positions of a charger and the like is increased by reduction of size of the hybrid drive unit 90.

The above description is merely one embodiment, and the present invention can be implemented in a mode in which various modifications and improvements are added based on knowledge of those skilled in the art.

### NOMENCLATURE OF ELEMENTS

10: electric vehicle
14: drive wheel
16: power transmission device
18: casing
50: high-voltage battery (driving battery)
54: electric-power control unit (electric-power control apparatus)
74: electric oil pump
84: cooling oil passage
84a: pre-cooler intermediate oil passage
   (oil passage between branch portion and oil cooler)
84eu: MG2 overlay oil passage
   (oil passage disposed adjacent to and above second electric motor)
86: lubricating oil passage
88: branch portion
90: hybrid drive unit (mechanical-electrical integrated unit)
92: transaxle (drive apparatus)
94: oil cooler
96: control valve
CL1: first axis (rotation axis of electric motor)
CL2: second axis (rotation axis of power transmission device)
CL3: third axis (rotation axis of second electric motor)
CL4: fourth axis (rotation axis of power transmission device)
FLD: oil
MG1: first electric motor (electric motor)
MG2: second electric motor
RSmg1: MG1 rotor shaft (rotor shaft of electric motor)

What is claimed is:

1. An electric vehicle comprising:
an electric motor;
a power transmission device to which the electric motor is connected in a power transmittable manner;
an electric oil pump configured to discharge an oil;
a cooling oil passage configured to supply the oil to the electric motor for cooling the electric motor;
a lubricating oil passage configured to supply the oil to the power transmission device for lubricating the power transmission device;
a branch portion configured to distribute the oil between the cooling oil passage and the lubricating oil passage;
an oil cooler provided in the cooling oil passage; and
a control valve which is provide in the branch portion and which is configured to make a ratio of a flow rate of the oil distributed to the lubricating oil passage higher when a temperature of the oil is low than when the temperature of the oil is high.

2. The electric vehicle according to claim 1,
wherein the control valve is to be opened and closed to control a flow rate of the oil distributed to an oil passage between the branch portion and the oil cooler, such that the control valve is fully closed or not fully opened when the temperature of the oil is not higher than a predetermined oil temperature value.

3. The electric vehicle according to claim 2,
wherein the control valve is fully opened when a temperature of the electric motor is higher than a predetermined motor temperature value.

4. The electric vehicle according to claim 1, further comprising:
a casing that houses a drive apparatus that includes the electric motor and the power transmission device;
a driving battery;
an electric-power control apparatus configured to control an electric power transmitted and received between the battery and the electric motor,
wherein the casing houses a mechanical-electrical integrated unit that is constituted by the drive apparatus and the electric-power control apparatus,
wherein the electric-power control apparatus is disposed adjacent to and above the electric motor in a vertical direction of the electric vehicle, and
wherein the cooling oil passage is configured to supply the oil to the electric motor via a rotor shaft of the electric motor.

5. The electric vehicle according to claim 4,
wherein the drive apparatus includes a second electric motor in addition to the electric motor as a first electric motor,
wherein the second electric motor is connected to a drive wheel of the electric vehicle in a power transmittable manner, and is housed in the casing,
wherein the cooling oil passage is configured to supply the oil to the second electric motor so as to cool the second electric motor,
wherein the drive apparatus is disposed in the electric vehicle, such that a rotation axis of the first electric motor, a rotation axis of the second electric motor and a rotation axis of the power transmission device are parallel to a horizontal direction that is perpendicular to a longitudinal direction of the electric vehicle, and such that the rotation axis of the second electric motor and the rotation axis of the first electric motor are arranged in this order of description from above to below in the vertical direction,
wherein the electric-power control apparatus includes a lower-side portion which is located in a position overlapping with an upper-side portion of the second electric motor as seen in the longitudinal direction and which is located above the first electric motor in the vertical direction, and
wherein the cooling oil passage is configured to supply the oil to the second electric motor via an oil passage that is disposed adjacent to and above the second electric motor in the vertical direction.
